(19) United States
(12) Patent Application Publication
(10) Pub. No.: US 2025/0263600 A1
(43) Pub. Date: Aug. 21, 2025

(54) LIGHT-EMITTING POLYMER FILM AND PROCESS OF ITS FORMATION

(71) Applicant: Zeljko MANDIC, Novi Sad (RS)

(72) Inventor: Zeljko MANDIC, Novi Sad (RS)

(21) Appl. No.: 18/857,841

(22) PCT Filed: Jul. 6, 2022
(86) PCT No.: PCT/RS2022/000012

§ 371 Date: Oct. 18, 2024

(30) Foreign Application Priority Data
May 10, 2022 (RS) P-2022/0432

(51) Int. Cl. C09K 11/06

(52) U.S. Cl. CPC C09K 11/06

(57) ABSTRACT

According to the invention, the light-emitting polymer film functions as a complex optical system, which applied within the structure of an edge-illuminated system with its entire front surfaces or part of its front surfaces in the form of a selected motif can emit uniform light beams to the outside. The light-emitting polymer film is made of a clear optically transparent polymer material by applying the spray coating technique, which consists of three structurally interconnected layers: contact layer (1), active optical layer (2) and protective layer (3). The active optical layer (2) contains a mixture of different types of glass particles (A), (B), (C) and (D), where the presence of each individual type of glass particles (A), (B), (C) and (D) in the structure of active optical layer (2) is defined by their quantity, size and geometric shape, the value of the refractive index of light and other physical characteristics. The contact layer (1) on one side and the final layer (3) on the other side prevent direct physical contact between the active optical layer (2) and the outside environment.

### TECHNICAL FIELD

According to the invention, the light-emitting polymer film is an innovative light emission product. The said invention relates to the field of optical elements with control of position or direction of light rays. According to the International Patent Classification, the relevant invention is marked: G02F 1/29 (2006.01) and G02B 5/02 (2006.01).

### TECHNICAL PROBLEM

The technical problem resolved with this finding is how to form a light-emitting polymer film, which, applied within the structure of an edge-illuminated system with its entire front surfaces or part of its front surfaces in the form of a selected motif can emit uniform light beams to the outside, which is colourless, optically clearly transparent, resistant to exposure to mechanical, temperature and chemical influences of the external environment and resistant to the effects of solar UV radiation.

### BACKGROUND ART

The edge-illuminated systems are used for backlighting for LCD screens, and more recently they are being used for lighting fixtures. LEDs are increasingly used in backlight assemblies for extended color, longer life, increased optical efficiency and cost. However, utilization of the same white spot diffussers scatters the light in all directions, to the critical angle for the air interface of the light guide. Refracted angular scattering of light outside the light guide can reach large angles relative to the surface, in which case optical films are necessary to return some of this light to normal or desired viewing angles.

Other backlight configurations were suggested by using symmetrical scattering particles instead of white spots. Okumura et al (J. Opt. A: Pure Appl. Opt. 5 (2003) S269-S275) described light guides for scattering as polymers of “highly scattered optical transmission” (HSOT). The authors demonstrated that backlighting based on HSOT polymer has the potential to provide twice greater illumination than the conventional backlighting. However, the used particles are symmetrical or spherical in shape. Okumura's teachings do not take into account the asymmetric nature of the incoming light, or the need to scatter more light vertically, horizontally or outside from the main side of the light guide. Also, traditional designs that use planar light guides such as those used on LCD screens have limitations in regards to angular output, heat, uniformity, efficiency and shape factors. Light from light source such as LEDs falling on volumetrically scattered light guides can have significantly bright regions near LEDs due to light that directly reaches the volumetric scattering area and causes uneven brightness on the surface emitting light near the edge of the light guide. If the intensity of diffusion (angular FVHM intensity of diffusion profile) of the volumetric light scattering of the light guide is significantly reduced to prevent high-brightness unevenness near the edge, optical efficiency of the light guide is also reduced.

US patent claim no. US 2018/0039009 A1, published on 8 Feb. 2018, includes a technical solution for a display backlight device and an associated display based on design and operating principles which are substantially different from the design, application and operating principles of the present invention in that, according to the relevant claim, light-transmitting particles contact the base layer or light guide plate which is not the case with the present invention where, quite the contrary, the glass particles contained in the structure of the active optical layer do not make direct physical contact with the external environment. The refraction index of the light-transmitting layer in the said patent application ranges from about 1.1 to about 1.3, which leads to the conclusion that the materials from which the light-transmitting layer can be derived belong to the group of very expensive and chemically unstable materials, non-resistant to the effect of solar UV radiation and non-resistant to other environmental influences. The light-transmitting particle has an exclusively spherical shape. which is not the case with the present invention-on the contrary, it is recommended that two of the four types of glass particles contained in the structure of the active optical layer have a polycrystalline shape. The front surface of the light guide plate is treated to contain a concave-convex matrix, which leads to the conclusion that it is a technologically complex and expensive process of execution, while the present invention does not have any technical requirements for specific treatment of any front surface. Also, the said patent application has design elements and working principle that are optimized in detail for display backlighting and does not meet the basic technical requirements for use in interior or exterior architecture in the way in which the light emitting polymer film is applied in interior and exterior architecture.

The U.S. Pat. No. 8,033,706 B1 patent published on 11 Oct. 2011 describes a LED-backlit LCD whose technical solution is based on the structure that involves the use of optical materials with extremely low value of the refractive index of light, which leads to a conclusion that the materials that make up the structure are from a group of very expensive and chemically unstable materials, non-resistant to the effects of solar UV radiation in the long run and non-resistant to other environmental influences, with a matrix representation of optical elements, which leads to the conclusion that it is a technologically complex and expensive implementation procedure, where its operating principle and structural elements are optimized for LCD backlighting and it does not meet basic technical requirements for use in interior or exterior architecture unlike the present invention where the structural elements do not contain optical materials with a low value of refractive index and matrix representation of the optical elements.

Patent claim number WO 2019/072938 A1, published on 18 Apr. 2019, involves a technical solution for the light guide plate as a lighting device which involves the use of optical elements in the form of particles contacting the base layer or light guide plate, which is not the case with the structure of the present invention where, quite the contrary, glass particles contained in the structure of active optical layer do not make direct physical contact with the external environment. This claim implies the use of photo-luminiscent elements that emit light of different wavelengths than the wavelength of incident light, which is not the case with the present invention where the structure does not use optical elements that change the wavelength of incident light.

The U.S. Pat. No. 9,803,819 B2 patent published on 31 Oct. 2017, involves a technical solution for a transparent general purpose lighting device based on the use of dielectric particles of different classes such as metal oxides, silicates, glass beads, plastic beads, barium sulfate, inorganic phosphors, orthosilicates, aluminosilicates, nitrides, europium doped oxynitrides, alternatively luminous paint dispersions, etc., the principle of which is based on the dispersion of dielectric particles in the light guide plate structure and their function is to enable diffuse scattering of the light beam coming from the edges of the diffusion plate, which is not the case with the present invention which contains four different types of glass particles in a defined interrelationship, with defined different geometric shapes and defined different values of the refractive index of light, so that the optical interaction of these light particles with the primary light beam is not based on simple diffusion but on a complex reflection both at the internal level in the structure of the light-emitting polymer film and at the external level in the relation of the light-emitting polymer film to the external environment. Also, the mentioned patent includes a technical solution which is considered to be optically transparent but not optically clear, considering the concentration of dielectric particles in the structure of the light guide plate, which is not the case with the relevant invention where the glass particles-which are normally transparent, but are also completely coated with a polymeric material, exhibit a very low degree of translucency in the visible light spectrum.

According to the invention, the form of the light-emitting polymer film meets all the technical and safety requirements for application in the architecture of interior and exterior as a functional and ambient lighting body and operates on principles that are fundamentally different from the principles that apply to the above technical solutions and other similar solutions that are not listed and belong to the existing background art.

### DISCLOSURE OF INVENTION

According to the invention, the light-emitting polymer film functions as a complex optical system, which is applied within the structure of edge-illuminated system so that its entire front surfaces, or a certain part of its front surfaces, can emit uniform light beams to the outside in the form of a selected motif.

The light-emitting polymer film is formed from transparent, optically clear polymeric material by applying the spray coating method, which has a compact structure made of three structurally interconnected layers, executed from identical polymeric material: contact layer, active optical layer and protective layer, where the contact layer located on one side and the protective layer on the other side prevent direct physical contact between the active optical layer and the outside environment.

The active optical layer contains a mixture of four types of glass particles, where the presence of each individual type of glass particles in the structure of active optical layer is defined by their quantity, size and geometric shape, value of the refractive index of light and other physical characteristics.

The light-emitting polymer film may be applied to one or both front surfaces of the edge-illuminated glass plate, rigid polymer plate, elastic polymer plate/film, on one front surface of self-adhesive polymer film and independently applied as an insert between two thermoplastic interlayer films within the structure of two-layer or multi-layer edge-illuminated laminate glass. If the light-emitting polymer film has been applied in the structure of the edge-illuminated system so that it emits uniform light beams throughout its frontal surfaces, then the edge-illuminated system works as a decorative ambient lighting fixture and/or as an optical barrier to protect privacy from outside views. If the light-emitting polymer film has been applied in the structure of the edge-illuminated system so that it emits uniform light beams in the form of a selected motif along a part of its frontal surfaces, then the edge-illuminated system works as a decorative ambient lighting fixture and/or as a double-sided promotional light panel.

### BRIEF DESCRIPTION OF DRAWINGS

The invention will be described in more detail below based on preferred illustrative executions, to which, however, it should not be limited, and with reference to the accompanying drawings, where:

FIG. 1—represents a schematic front view of a light-emitting polymer film with a front surface of a typical rectangular shape in vertical cross section A-A′ and horizontal cross section B-B′;

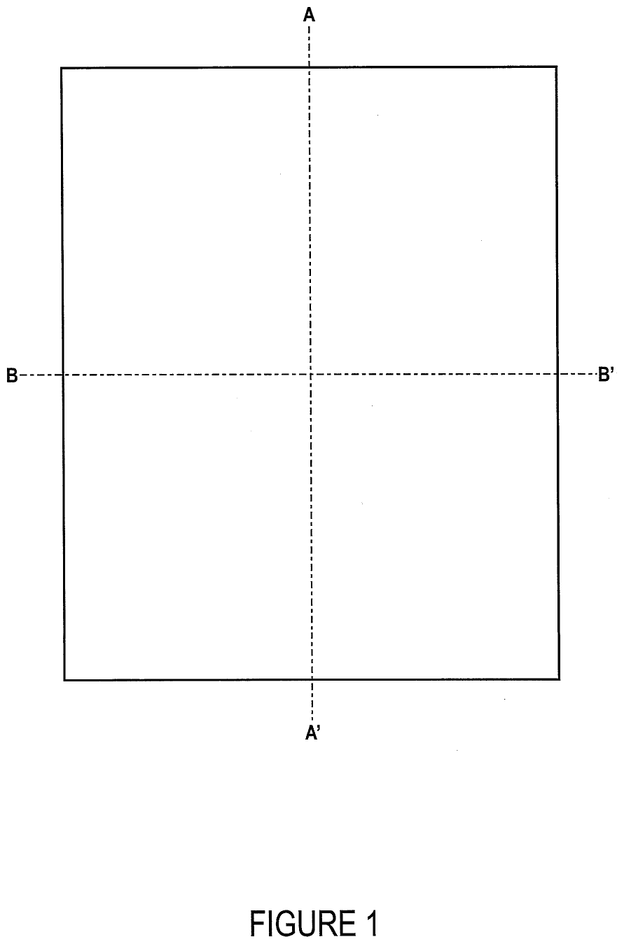

FIG. 2—represents a a light-emitting polymer film which can emit uniform light beams towards the outside environment along its entire front surfaces, in a vertical cross-section A-A′;

FIG. 3—shows the stages of the process of forming a light-emitting polymer film which can emit uniform light beams along its entire front surfaces when applied to the front surface of an edge-illuminated background, in horizontal cross section B-B′;

FIG. 4—represents a distribution of light when a light-emitting polymer film is applied to the front surface of an edge-lit base so that its entire front surfaces emit uniform light beams to the outside environment, in a vertical cross section A-A′;

FIG. 5—shows the stages of the process of forming a light-emitting polymer film which can emit uniform light beams along its entire front surfaces if applied subsequently, in a separate technological process, as insertion between two interlayer thermoplastic films, as part of the structure of a double-or multi-layer edge-lit laminated glass, in horizontal cross-section B-B′;

FIG. 6—shows the stages of the process of forming a light-emitting polymer film which can emit uniform light beams along a part of its front surfaces towards the outside environment, in the form of a selected motif, when applied to the front surface of an edge-lit base, in horizontal cross-section B-B′;

FIG. 7—represents a display of light distribution when a light-emitting polymer film is applied to the front surface of an edge-lit base so that part of its front surfaces emits uniform light beams to the outside in a form of a selected motif, in vertical cross section A-A′;

FIG. 8—shows the stages of the process of forming a light-emitting polymer film which can emit uniform light beams towards the outside environment through a part of its front surfaces, in the form of a selected motif, if applied subsequently, in a separate technological process, as insertion between two interlayer thermoplastic films, as part of the structure of a double-or multi-layer edge-lit laminated glass, in horizontal cross-section B-B′;

### BEST MODES FOR CARRYING OUT THE INVENTION

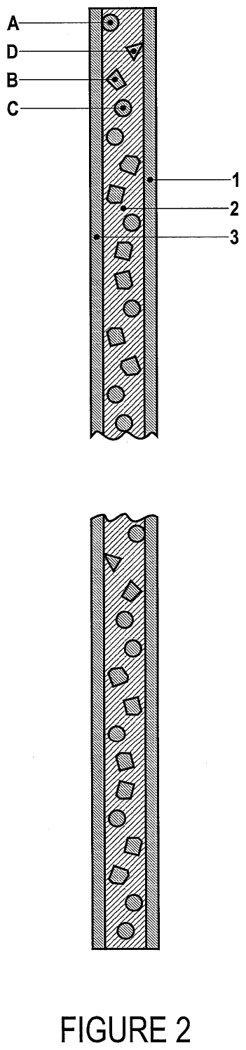

The light-emitting polymer film which, according to the invention, can emit uniform light beams towards the external environment along its entire front surfaces, is shown in FIG. 2, in vertical cross-section A-A′.

The light-emitting polymer film was made from a transparent polymeric material based on acrylic or polyurethane binding agents in organic or aqueous solvent, or on a mixture of acrylic and polyurethane binding agents in an organic or aqueous solvent, which is suitable for application by using a spray coating technique because of its viscosity and which is optically clearly transparent. Also, after polymerization, its fire class is at least B-s1-d0 according to the EN13501-1 standard, the value of its light refractive index is less than 1.5, it is long-term resistant to exposure to mechanical, temperature and chemical influences from the environment and the effects of UV radiation.

The light-emitting polymer film itself consists of three structurally connected layers: contact layer 1, active optical layer 2 and protective layer 3, all of which are formed from identical polymeric material.

Contact layer 1 is 30 μm thick and its function is to establish contact and adhesion of the light-emitting polymer film with the front surface of the edge-lit system, thus preventing direct physical contact of the active optical layer 2 with the external environment.

Active optical layer 2 is 100 μm thick and it is positioned between the Contact layer 1 and Protective layer 3 so as to prevent the Contact layer 1 and Protective layer 3 to make direct physical contact with each other at any point on the surface. The active optical layer 2 contains a mixture of four types of optically clearly transparent glass particles A, B, C and D.

Glass particles for external reflection A are transparent, spherical, of a recommended diameter of 35 μm or less, having a light refractive index of 2.2 or greater, they make up 6.2 grams in cm³ of volume of polymerized active optical layer 2. Glass particles for external reflection B are transparent, polycrystalline, with a recommended diameter of 35 μm or less, having a light refractive index of 2.2 or greater, they make up 5.8 grams in cm³ of volume of polymerized active optical layer 2. Glass particles for external reflection C are transparent, spherical, with a recommended diameter of 35 μm or less, having a light refractive index in the range from 1.51 to 1.6, they make up 3.1 grams in cm³ of volume of polymerized active optical layer 2. Glass particles for external reflection D are transparent, polycrystalline, with a recommended diameter of 35 μm or less, having a light refractive index between 1.51 and 1.53, they make up 2.85 grams in cm³ of volume of polymerized active optical layer 2.

Protective layer 3 is 30 μm thick and its function is to prevent direct physical contact of active optical layer 2 with the external environment, and thus protect it from external influences.

The light-emitting film formed according to the relevant invention is 85% transparent on the visible light spectrum, and translucency value is less than 2%

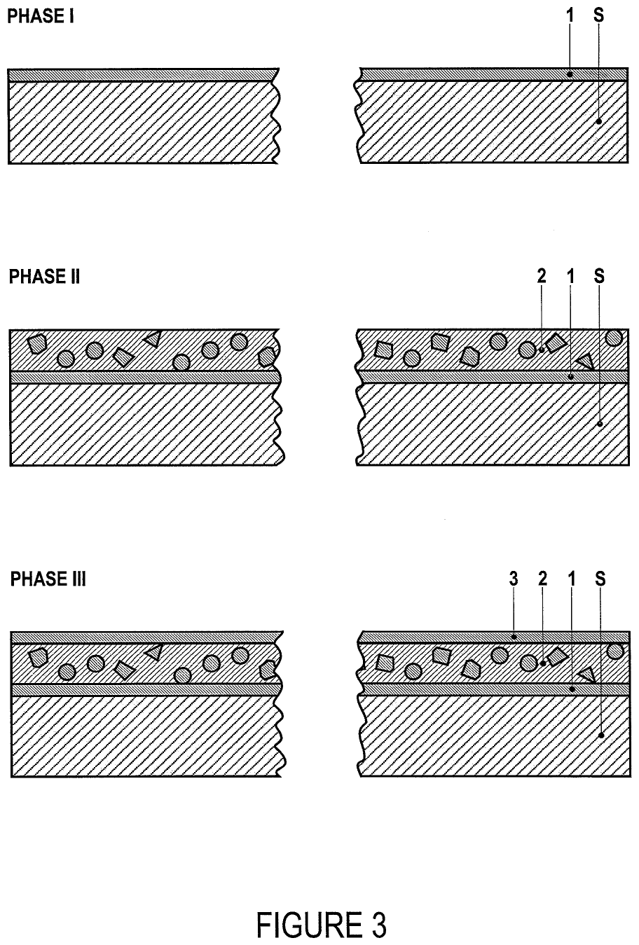

The process of forming a light-emitting polymer film which can emit uniform light beams along its entire front surfaces when applied to the front surface of an edge-lit base S is performed in several phases, and the phases of process are shown in FIG. 3, in horizontal cross-section B-B′, wherein the base S can be made in the form of a rigid, transparent glass or polymer plate or in the form of an elastic transparent polymer plate/film.

In the preparatory phase of the procedure, thorough cleaning and degreasing of the front surfaces of base C is performed and three separate liquid polymer mixtures are prepared: for contact layer 1, for active optical layer 2 with the addition of glass particles A, B, C and D according to the defined technical specification, and for final layer 3.

The first phase of the process of applying liquid polymer mixture for contact layer 1 is performed by spray painting the mixture as recommended on the entire front surface of the base S, followed by a 2-10 minute break before the next phase in the process.

The next phase of applying liquid polymer mixture for active optical layer 2 is performed by spray painting the entire front surface as recommended, over the previously applied contact layer 1, followed by a 2-10 minute break before the next phase in the process, which is also the final phase.

The application of the active optical layer 2 itself takes place using a low-capacity spray coating system where the liquid polymer mixture for active optical layer 2 is in a spray gun pressure vessel immediately before and at the time of application, where this vessel has an integrated adjustable air powered mixer which constantly mixes the liquid polymer mixture for the active optical layer 2 which prevents gravitational depositing of glass particles A, B, C and D at the bottom of the spray gun vessel and allows later relatively uniform spatial arrangement of glass particles A, B, C and D in the structure of the active optical layer 2.

Application of the active optical layer 2 can also take place using a higher capacity spray coating system where the liquid polymer mixture for active optical layer 2 is in a pressurized vessel located in the preparation group immediately before and at the time of application, before using the spray gun, the vessel has an integrated adjustable mixer that constantly mixes the liquid polymer mixture for optically active layer 2 which prevents gravitational deposition of glass particles A, B, C and D at the bottom of the vessel and allows relatively homogeneous spatial arrangement of glass particles A, B, C and D in the structure of the optical active layer 2.

In the last phase, the liquid polymer mixture for final layer 3 is also spray painted in the recommended thickness to the entire front surface of the previously applied active optical layer 2, where in the mentioned final phase, in addition to the application process, the process of polymerization of the applied layers also takes place, which results in the forming of a light-emitting polymer film that is functional.

The mentioned layers of the light-emitting polymer film are applied in corresponding clean spray painting chambers with appropriate filtration and ventilation, where the air temperature in the chamber space is around 20° C.

It is recommended to perform the layer polymerization process and the formation of the light-emitting polymer film at a recommended room temperature of around 20° C. for about 24 hours or at a recommended room temperature of around 60° C. for about 1 hour, or if the selected polymer mixture is suitable for UV polymerization, at the recommended room temperature of around 20° C. with the presence of electrically generated UV radiation for about 2 minutes.

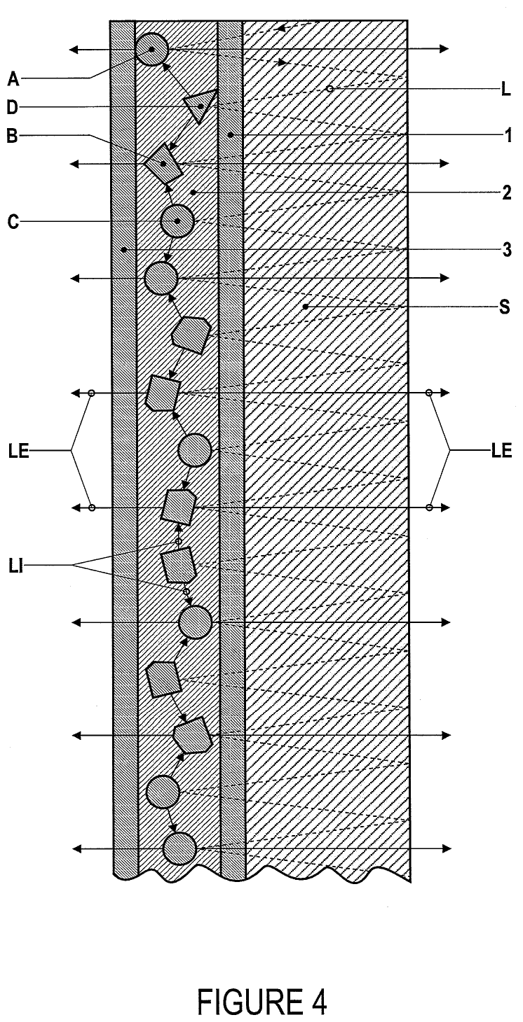

The distribution of light when a light-emitting polymer film is applied to the front surface of the edge-lit base S so that it emits uniform light beams outwards along its entire front surfaces, is shown in FIG. 4, as vertical cross section A-A′. At least one edge of base S has an installed electrical light source which generates the primary light beam L. The primary light beam L spreads from one edge of base S towards its other parallel edge through its cross section, engaging in optical interaction with each individual glass particle A, B, C and D within the active optical layer 2. Optical interaction of the primary light beam L with glass particles A and B for external light reflection generates external secondary beams LE in them, and these beams spread from front surfaces of the light-emitting polymer film towards the outside by forming uniform light beams. Optical interaction of the primary light beam L with glass particles C and D for internal reflection generates internal secondary beams LI in them, and these beams spread through the cross section of active optical layer 2 towards surrounding glass particles. The relatively uniform spatial arrangement of glass particles A, B, C and D within the active optical layer 2 allows spatially uniform distribution of internal secondary light beams LI through the cross section of active optical layer 2 and allows spatially uniform distribution of external secondary light beams LE, from front surfaces of the light-emitting polymer film towards the outside. The light distribution principle remains the same and if the light-emitting polymer film is applied as insertion between two thermoplastic interlayer films within the structure of double-layer or multi-layer edge-lit laminate glass so as to emit uniform light beams towards the outside along its entire frontal surfaces.

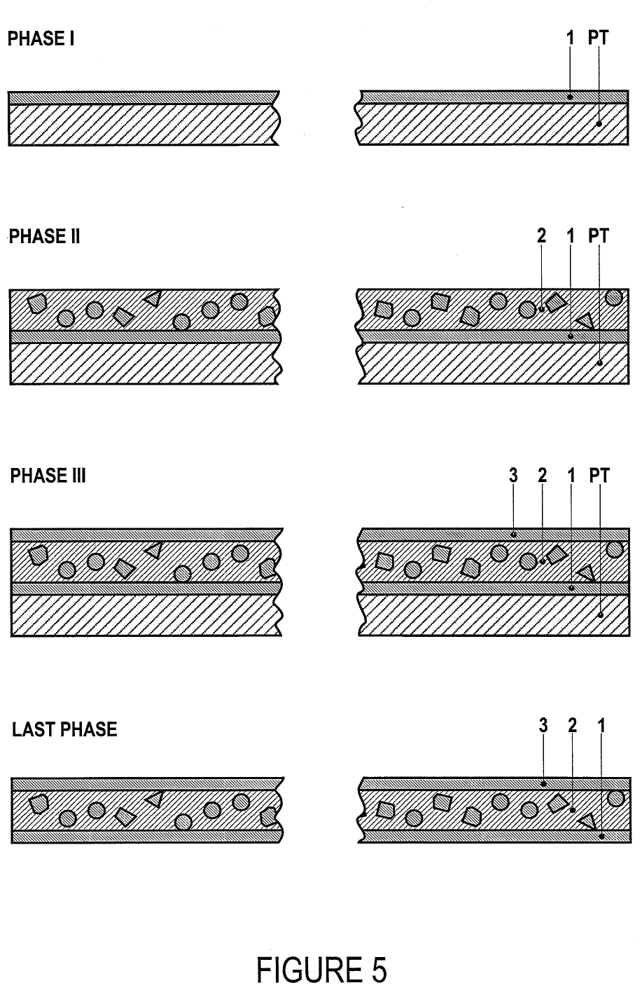

The following example of implementation of the present invention shows that the light-emitting polymer film can emit uniform light beams along its entire frontal surfaces if it is subsequently independently applied in a separate technological procedure as insertion between two thermoplastic interlayer films within the structure of double-layer or multi-layer edge-lit laminate glass. The process of forming a light-emitting polymer film shown in FIG. 5, in the horizontal cross section B-B′, is identical to the previously mentioned procedure where the polymerization of applied layers also takes place in the final stage of the procedure, after which the formed light-emitting polymer film get physically separated from the front surface of the polymer plate/film PT, so that it is suitable for subsequent use in the structure of double-layer or multi-layer edge-lit laminated glass. The polymer plate/film PT has a smooth, non-stick surface and it is made of chemically innert, thermostable material—polytetrafluoroethylene.

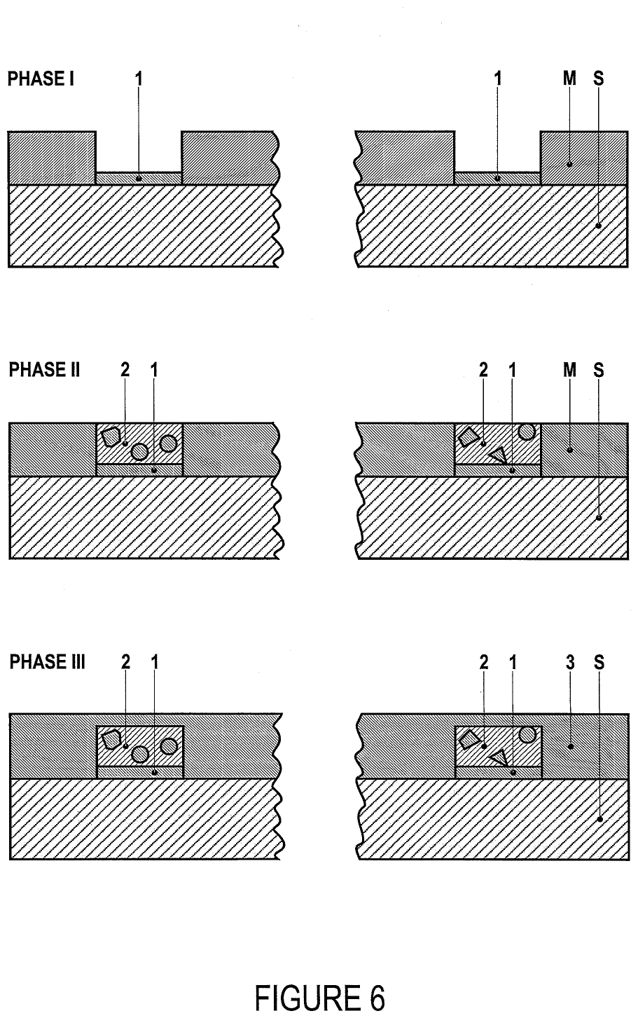

The following example of implementation of the present invention shows that the light-emitting polymer film can emit uniform light beams on one part of its front surfaces in the form of the selected motif, when it is applied on the front surface of the edge-lit base S, and the light-emitting polymer film forming procedure is shown in FIG. 6, in horizontal cross section B-B′.

The procedure itself, just like the previous procedures, consists of the preparatory phase, where thorough cleaning and degreasing of front surfaces of the base S and preparation of three separate liquid polymer mixtures for contact layer 1, for active optical layer 2 with the addition of glass particles A, B, C and D according to the defined technical specification and for the final layer 3, where the previously prepared mask M, preferably made of self-adhesive polymer film, with holes cut on CNC machine that carry the contours of the selected motif, is temporarily applied to the entire front surface of base S in the preparatory phase of the procedure.

In the phase of applying the liquid polymer mixture for contact layer 1, the liquid polymer mixture is spray painted in the recommended thickness to the entire front surface of mask M, where contact layer 1 will make physical contact and adhesion with the front surface of base S in the zones of openings on mask M, followed by a 2-10 minute break before the next phase in the process.

In the phase of applying the liquid polymer mixture for active optical layer 2, the liquid polymer mixture is spray painted in the recommended thickness to the entire front surface of the previously applied contact layer 1, after which mask M will be separated from front surface of base S, followed by a 2-10 minute break before the next phase in the process.

In the final stage of the procedure, the liquid polymer mixture for final layer 3 is spray painted in the recommended thickness to the entire front surface of base S, including the zones where contact layer 1 and active optical layer 2 were previously applied, whereby polymerization of the applied layers takes place in the final phase of the procedure, which results in the formation of a light-emitting polymer film that is functional.

Contact layer 1 and active optical layer 2 of light-emitting polymer film were executed in the form of the selected motif so as to include only part of the front surface of the light-emitting polymer film, while the final layer 3 includes the entire front surface thus enabling the compactness of the light-emitting polymer film.

In the shown example, contact layer 1 and active optical layer 2 were executed in the form of two vertically oriented rectangular fields, and can be made in the form of any motif (for example, as a logo, lettering, decorative motif, etc.). All technical specifications of the contact layer 1, active optical layer 2 and the final layer 3 previously mentioned and described for the light-emitting polymer film which can emit uniform light beams to the outside along its entire front surfaces, also fully apply to this case of light-emitting polymer film which can emit uniform light beams to the outside in part of its front surfaces, in the form of a selected motif.

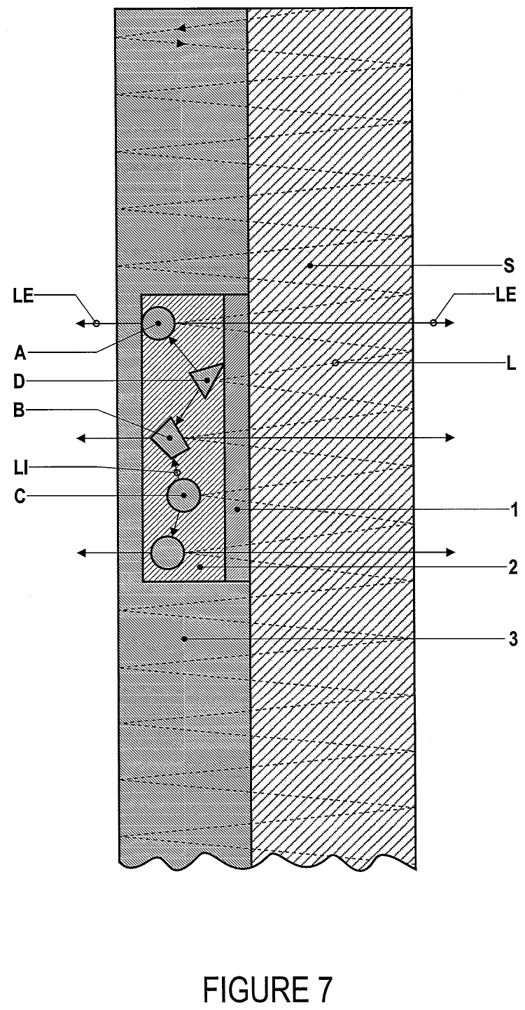

The distribution of light when a light-emitting polymer film is applied to the front surface of the edge-lit base S so that it emits uniform light beams outwards along part of its front surfaces, is shown in FIG. 7, as vertical cross section A-A′. Distribution of light in the given example is identical to the above example where the light-emitting polymer film is applied to one front surface of the edge-lit base S so that its entire front surfaces emit uniform light beams to the outside environment.

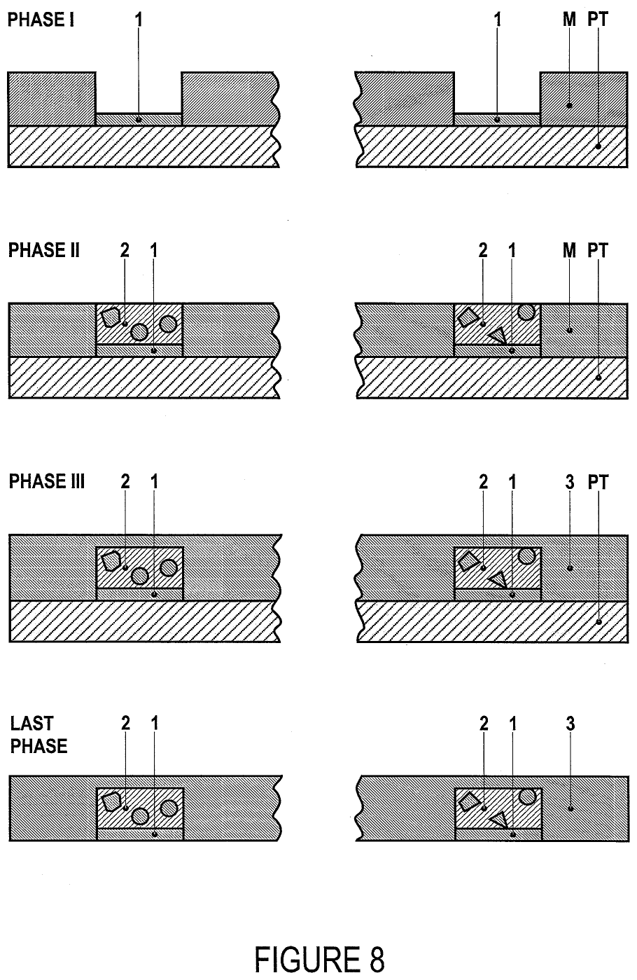

The following example of implementation of the present invention shows that the light-emitting polymer film can emit uniform light beams in one part of its front surfaces in the form of the selected motif if it is subsequently independently applied in a separate technological procedure as insertion between two thermoplastic interlayer films within the structure of double-layer or multi-layer edge-lit laminate glass. The process of forming a light-emitting polymer film shown in FIG. 8, in the horizontal cross section B-B′, is identical to the previously mentioned procedure for forming a light-emitting polymer film where the polymerization of applied layers also takes place in the final stage of the procedure, after which the formed light-emitting polymer film get physically separated from the front surface of the polymer plate/film PT, so that it is suitable for subsequent use in the structure of double-layer or multi-layer edge-lit laminated glass.

All the above examples of execution of the relevant invention can also be amended without deviating from the inventive concept of the relevant invention as defined in the patent claims.

1. Light-emitting polymer film made of transparent polymers, characterized by the fact that, it consists of a contact layer (1), active optical layer (2) and final layer (3), whereby the contact layer (1) makes contact and adhesion of the light-emitting film with the surface, while the final layer (3) prevents direct physical contact of active optical layer (2) with the external environment and protects from external influences.

2. Light-emitting polymer film according to claim 1, characterized by the fact that, the active optical layer (2) contains a mixture of four types of optically clear transparent glass particles (A), (B), (C) and (D), where glass particles (A) and (B) are intended for external reflection of light, while glass particles (C) and (D) are intended for internal reflection of light.

3. Light-emitting polymer film according to claims 1 and 2, characterized by the fact that, the glass particles (A) and (C) are spherical, with diameter of 35 μm or less, while glass particles (B) and (D) are polycrystalline in shape, with granulation of 35 μm or less.

4. Light-emitting polymer film according to one of the claims 1 to 3, characterized by the fact that, the light refractive index in glass particles (A) and (B) is 2.2 or greater, while light refractive index in glass particles (C) and (D) ranges from 1.5 to 1.6.

5. Light-emitting polymer film according to one of the claims 1 to 4, characterized by the fact, that thickness of the contact layer (1) is 30 μm, thickness of active optical layer (2) is 100 μm and thickness of protective layer (3) is 30 μm.

6. The process of making a light-emitting polymer film consists of:
preparatory phase, which includes thorough cleaning and degreasing of front surfaces of the base and preparation of three separate liquid polymer mixtures for contact layer (1), for active optical layer (2) and for the final layer (3);
phase of applying contact layer (1) which is applied by spray painting;
phase of applying active optical layer (2) which is applied by spray painting;
phase of applying final layer (3) which is applied by spray painting; and
phase involving the polymerization of the applied layers.

7. Procedure according to claim 6, characterized by the fact that, the break between coats (1) and (2) will be between 2 and 10 minutes.

8. Procedure according to claim 6, characterized by the fact that, air temperature for applying layers (1) and (2) and (3) in the spray painting chamber is around 20° C.

9. Procedure according to claim 6, characterized by the fact, that polymerization takes place at air temperatures from 20° C. to 60° C., lasting from 2 minutes to 24 hours.

10. Procedure according to claim 6, characterized by the fact, that after polymerization, when the polymer plate/film (PT) is applied, we see physical separation of the light-emitting polymer film which is suitable for subsequent application on the structure of the double-layer or multi-layer laminated glass.
